(19) United States
(12) Patent Application Publication
(10) Pub. No.: US 2013/0229328 A1
(43) Pub. Date: Sep. 5, 2013

(54) METHOD AND DEVICE FOR REDUCING IMAGE STICKING IN LIQUID CRYSTAL DISPLAY PANELS, COMPUTER PROGRAM, AND DATA CARRIER

(71) Applicants: Sven Adler, Esslingen (DE); Achim Rausenberger, Ohringen (DE)

(72) Inventors: Sven Adler, Esslingen (DE); Achim Rausenberger, Ohringen (DE)

(73) Assignee: PEPPERL + FUCHS GMBH, Mannheim (DE)

(21) Appl. No.: 13/599,073

(22) Filed: Aug. 30, 2012

Related U.S. Application Data
(60) Provisional application No. 61/529,978, filed on Sep. 1, 2011.

(51) Int. Cl. G09G 3/36

(52) U.S. Cl. CPC G09G 3/36
USPC 345/89

(57) ABSTRACT

The invention relates to a method for reducing image sticking in liquid crystal display panels, in which the liquid crystal display panel is controlled by a control program running on a logic device, in which at least a number of selected pixels in the liquid crystal display panel are subjected to modified control at least for specified periods of time instead of the control normally necessary to display a specific image. The modified control is carried out under the condition that the maximum contrast between the selected pixels and their adjacent pixels is reduced. The invention further relates to a device for reducing image sticking and also to a computer program and a data carrier.

### TECHNICAL FIELD

The present invention relates, in a first aspect, to a method for reducing image sticking in liquid crystal display panels.

In further aspects, the invention relates to a device for reducing image sticking in liquid crystal display panels and to a computer program and a machine-readable data carrier.

### RELATED ART

The retention of, typically, static images in liquid crystal display panels is referred to as “image sticking.” This effect is evident to a very great extent in the case of large panel diagonals and high temperatures, but the specific physics of this phenomenon are not entirely known as yet.

In particular, observations also reveal fluctuations within a production batch of liquid crystal display panels. Even within a panel, there are differences, that is to say, there are regions that are more greatly affected by image sticking than others. The reason for this could reside in specified circumstances arising in the production of liquid crystal display panels that react on the electrochemical properties of the LCD liquid.

The problem of image sticking is particularly relevant to panels used in industrial surroundings, for example, in automation engineering, since this field involves the extensive use of high-contrast monochromatic large-area flow diagrams that increase the effect of image sticking. Furthermore, such flow diagrams are very frequently expected to be displayed by long periods of time without interruption, there being no change of image when there is no user activity or user interaction.

The problem is intensified in explosion-proof regions, since the devices used in this case are usually cooled passively due to the protection against explosion. This results in higher temperatures in the interior of the device and thus also on the panel.

Large monitors or panels for flow diagrams, particularly those having panel diagonals larger than 15 inches and showing the image sticking effect either not at all or only to a minor degree are not available or, if so, are too costly.

In a generic method, the liquid crystal display panel is controlled by a control program running on a computing device, and at least a number of selected pixels of the liquid crystal display panel are subjected to modified control, at least during specified periods of time, instead of the control normally required for the display of a specific image.

A generic device comprises a computing device for controlling the liquid crystal display panel based on a control program running on a computing device, the control program being configured so as to subject at least a number of selected pixels of the liquid crystal display panel to modified control, at least during specified periods of time, instead of the control normally required for the display of a specific image.

A generic method and a generic device are described, for example, in WO 2007/025539 A2. The basic idea in this case is to carry out the modified control of the liquid crystal display panel so rapidly that the modulation is not perceivable to the human eye.

Further methods, each of which is relatively costly as regards hardware and software, are proposed in US 2011/007098 A1, EP 2 0 276 017 A1, US 2010/0097307 A1, EP 2 226 789 A1, and EP 1 094 437 A2.

### SUMMARY

The present invention provides a method and device for reducing image sticking in liquid crystal display panels. The method is very easy to carry out, yields satisfactory results, and does not involve expensive hardware supplementation.

According to the invention, the method of the aforementioned type is improved on by causing the modified control to be carried out under the condition that the maximum contrast between the selected pixels and their adjacent pixels is reduced.

According to the invention, the device of the above type is improved on by configuring the control program so as to carry out the modified control under the condition that the maximum contrast of the selected pixels and their adjacent pixels is reduced.

In order to prevent images from sticking, the liquid crystal display panel has hitherto been usually switched off for a defined period of time, for example, for one hour every 24 hours. Alternatively, a full-screen screensaver comprising moving image content is displayed when there is no user activity after a reasonably long period of time. Both are undesirable from the point of view of constant readability, least possible falsification of the original image content, and the ability to achieve maximum steadiness of the displayed image.

After extensive preliminary studies, the inventors found that the effect of image sticking is reduced significantly when the individual pixels of the liquid crystal display panel are controlled such that the contrast or the contrast range of the image is reduced over the entire panel. In particular, the inventors have found that strong differences in contrast between adjacent pixels are mainly responsible for image sticking.

The device of the invention is particularly suitable for executing the method of the invention.

Protection is additionally claimed for a computer program comprising program coding means for carrying out computation of the steps of the method of the invention when the computer program is executed on the computing device. Finally, protection is claimed for a machine-readable data carrier, on which program coding means are stored for carrying out computation of the steps of the method of the invention when the computer program is executed on the computing device.

It may be regarded as being one advantage of the method of the invention that, in principle, no additional hardware components are necessary and that image sticking can be suppressed satisfactorily whilst ensuring continuous readability of the liquid crystal display panel using comparatively simple software. In doing so, the brightness and colors can be basically retained.

A further advantage of the method of the invention resides in the fact that the original image content is modified only to a very small extent, and, in particular, method variants are readily achievable in which the original image content is modified such that it is subjectively virtually unnoticeable. In particular, a very steady display of the image content is also possible, which means that the user will not notice any shaking, flickering, or other disturbing movements in the image.

In an embodiment, the modified control is carried out under the condition that the contrast range of at least a portion of the image displayed on the liquid crystal display panel is reduced. Particularly simple and thus inexpensive alternative methods are feasible for this purpose, particularly when the contrast range is reduced over the entire image.

In principle, however, it is also possible to effect modified control under the condition that the average contrast between the selected pixels and their adjacent pixels is reduced.

Advantageously, this can be achieved by confining the modified control to regions showing very high contrast or contrasting edges, and thus by carrying out image-selective contrast reduction. This means that the modified control is carried out such that only pixels of which the contrast relative to their adjacent pixels exceeds a specifiable threshold are subjected to a reduction in contrast.

Basically, only a partial selection of defined pixels may be subjected to the modified control. However, in an embodiment of the method of the invention, all of the pixels of the liquid crystal display panel are subjected to the modified control.

Very satisfactory results are achieved when the control parameters for normal display of the image are altered for the purpose of determining the control parameters for the modified control such that the brightness of the pixels is scaled by means of a monotonic function.

In principle, this can be a monotonically enhancing function or a monotonically attenuating function.

Image sticking can be reduced very satisfactorily when the control parameters for the modified control are selected under the condition that the brightness of every single pixel is enhanced, while the darker the pixel is under normal display conditions, the greater is the change in brightness of the pixel as compared with the normal display conditions.

However, an embodiment including a reverse method variant may be advantageous for specified types of panels. For example, a method in which the control parameters for the modified control are selected under the condition that the brightness of every single pixel is reduced, and the brighter the pixel is under normal display conditions, the greater is the change in brightness of the pixel as compared with normal display conditions.

Extensive tests on a large variety of liquid crystal display panels have further revealed that the reduction of image sticking is particularly pronounced when the modified control is carried out for a period of at least several seconds.

In a further embodiment of the method of the invention, a first aliquot of pixels is initially subjected to the modified control for a defined period of time at the start of a cycle, and additional aliquots of pixels differing from each other and from the first aliquot are then each successively subjected to the modified control for a defined period of time until all of the pixels of the image have been subjected to the modified control. Subsequently, the first aliquot of pixels can again be subjected to the modified control for the defined period of time, that is to say, the cycle recommences. This method variant enables very individually defined parameters such as color temperature, brightness, and contrast of the image to be adjusted in a specific manner.

The optical quality of the panel content as regarded by a user can further be enhanced in a method variant in which the pixels of the liquid crystal display panel are subjected to normal control when there is user interaction, i.e. when the panel content is being changed. Any impairment, however small, of the optical quality of the panel content is then of no significance in critical phases, for example, when data are entered by a user.

A further advantageous embodiment of the method of the invention in this context is achieved when the modified control is started automatically when the image remains unchanged for a specifiable period of time. This is the case when, for example, no user activity or user interaction has taken place over a specifiable period of time. An improvement of this method variant is achieved when the modified control is applied only to that portion of the liquid crystal display panel that displays a static image for a specifiable period of time. Thus the modified control proposed by the invention takes effect only where it is actually necessary.

It is further advantageous for best possible perceptibility and readability, when the pixels of the liquid crystal display panel are subjected to the control used for normal display when there is a change of image content, particularly when there is user interaction.

In a further advantageous method variant, a reduction of the overall contrast ratio can further be achieved by deriving the control parameters for the modified control of a pixel from the control parameters used for the pixel under normal display conditions in that the control parameters for normal display conditions are modified so as to approach the average values for the control parameters of pixels in the vicinity of the pixel in question or so as to approach the average values of the control parameters of all pixels. This means that the distribution of the control parameters is reduced or, mathematically speaking, the standard deviation of the control parameters diminishes.

The extent of optical impairment of the image for a user as a result of the method of the invention can be adjusted, in principle, by modifying a fraction of the pixels that are simultaneously subjected to the modified control in accordance with the degree of perceptibility of the image to the user. Values that are useable in practice are in this case quickly acquired by trial and error.

The method of the invention is basically not dependent on additional hardware requirements, but in a particularly advantageous variant of the device of the invention, there is provided a microcontroller for controlling the liquid crystal display panel, which microcontroller comprises a programmable logic unit, for example a field programmable gate array (FPGA) on which the control program is stored. In this way, it is possible to carry out the method of the invention substantially by means of this microcontroller and otherwise to resort to commercially available components, for example, video cards.

### BRIEF DESCRIPTION OF THE DRAWINGS

Additional advantages and features of the method of the invention and of the device of the invention are described below with reference to the figure, in which components of the device of the invention are shown diagrammatically.

FIG. 1 diagrammatically illustrates an exemplary embodiment of a device according with the present invention.

### DETAILED DESCRIPTION

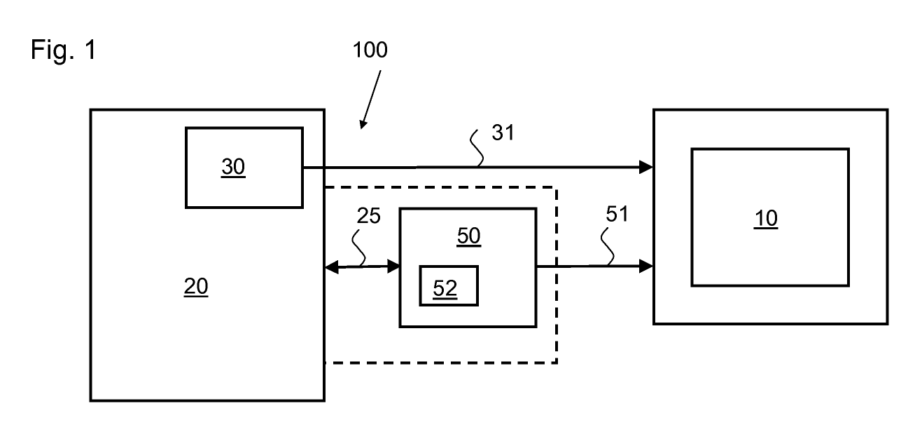

FIG. 1 diagrammatically illustrates an exemplary embodiment of a device 100 in accordance with the invention. The device 100 may include a computing device 20, for example, a PC adapted to control a liquid crystal display panel 10 by means of a video card 30 in the example shown. This is indicated diagrammatically by the arrow 31 in FIG. 1. The method of the invention is then executed using software stored in a memory of the video card 30 or in any other storage device of the computer 20.

In a different embodiment likewise shown in FIG. 1, there is provided a microcontroller 50 specifically for controlling the liquid crystal display panel 10 and for executing the method of the invention. In the example shown, the microcontroller 50 comprises a programmable logic unit 52, in which the software for carrying out the method of the invention may be stored. In this embodiment, the microcontroller represents the computing device on which the control program of the invention runs in order to control the liquid crystal display panel 10. This is shown in FIG. 1 by means of the arrow 51. The microcontroller 50 can be integrated in the computing device 20 or it may be a separate unit which interacts with the computing device 20 by means of a suitable connection or interface. This is indicated by the double arrow 25 in FIG. 1.

In an embodiment of the method of the invention that is particularly simple but nonetheless yields effective and satisfactory results, the brightness of all of the pixels may be increased. More specifically, black pixels, that is to say, pixels providing 0% intensity are raised to a gray value of 50%. Gray pixels providing 50% intensity can be raised to a light gray value of 75% of the maximum intensity. White pixels already providing 100% of the maximum intensity are left as is, that is, at 100% of the maximum intensity.

In a further method variant that has been tested in practice, the image, taken as a whole, is modified cyclically. For this purpose, selected pixels at a first position that have been specified according to a predetermined mask may be modified, that is to say, subjected to the modified control for a specific period of time. After a further specifiable time interval, the mask is shifted to another position, that is to say, another range of pixels may be now subjected to the modified control. This is repeated until ultimately all of the pixels of the panel have been modified, that is, subjected to the modified control. Then the cycle recommences, that is, the mask may be repositioned at the first position and thus the first range of pixels is again subjected to the modified control. The readability of the panel is basically retained in this variant, particularly when the viewing distance is large and the image structures are not too fine or too delicate.

One finding underlying the above method is the observation that the image sticking effect is significantly attenuated or even unnoticeable when each pixel is controlled, over an average period of time, in the same or similar manner as nearly as possible and displays the same color, for example, gray.

In one example, this can be achieved, for instance, by displaying each pixel in a normal or positive form and in an inverted or negative form for equally long periods of time. A shift in the contrast, brightness, and/or color temperature is likewise possible, although more complex to achieve.

Generally speaking, the pixels are shifted in the color space with time so that, on the one hand, the original image is still very clearly visible and, on the other hand, the average color displayed or the brightness, contrast, and/or the color temperature of the pixels are close to each other as nearly as possible.

In practice, a compromise must be reached between the clarity of the image and the greatest possible suppression of the image sticking effect.

For example, the method of the invention may utilize the effect that individual pixels are not perceived as individual dots from a defined distance, but rather they fuse or merge with their directly adjacent dots to form a large pixel. There thus results a very homogeneous and steady image from the point of view of the viewer. However, the overall contrast of the image diminishes. This is also referred to as “gray fog”. This effect is greater in liquid crystal display panels having a higher pixel density, in which individual pixels or their sub-pixels, i.e. red, green, and blue are hardly distinguishable to the human eye.

In principle, the method of the invention can operate in the manner of a screensaver that is activated (i.e., enters an active period) after a defined period of time in which there is no user activity has elapsed but turns itself off when the user resumes activity.

During the active period of the method of the invention, an image process is carried out on the liquid crystal display panel, by means of which the original image, that is, the normal display is modified continuously.

In a simple example, a XOR (exclusive OR) mask is placed over the image on the liquid crystal display panel. Where the mask bit is equal to 0, that will mean that the corresponding pixel remains unchanged and is thus not subjected to a modified control. On the other hand, where the bit of the corresponding mask is equal to 1, the corresponding pixel is modified. For example, the red/green/blue value of the corresponding pixel can then be inverted bit by bit.

After a period of time lasting, typically, for a few seconds, the mask is shifted, so that eventually all of the pixels of the liquid crystal display panel will have been subjected to the modified control, for example inverted, on the elapse of a sufficiently long period of time.

The ratio of unmodified to modified pixels or, in other words, of transparent to masked pixels, is governed by the actual data of the mask. The effect of the reduction of image sticking is relatively small for a small proportion of modified or masked pixels. The larger the proportion of masked pixels, i.e. the larger the proportion of pixels that have been subjected to the modified control, the greater and more effective is the suppression of image sticking. At ratios of 1:2, the image is readable from a distance of about 2 m and image sticking is suppressed very satisfactorily.

The user can, with specific software, make the following adjustments, for example: The period of time of no user activity, following which the method of the invention is activated; and the specific range of the mask that is placed over all the pixels of the panel. Thus it is possible to adjust the quality of the reduction of image sticking and the subjective image quality for the user. Furthermore, it is possible to adjust and alter the period of time during which the mask remains at a defined position, in other words, the period of time during which a defined range of pixels is subjected to the modified control. Furthermore, the frequency with which the background of the inverted mask is refreshed can be adjusted. Finally, it is possible to allow the method of the invention to act upon only a portion of the liquid crystal display panel being adjusted or upon the entire panel.

In principle, the positions of the pixels subjected to the modified control may be selected randomly. It is further possible to subject the selected pixels to the modified control for a very short period of time such that it is not discernible to the human eye. Furthermore, more complex shifts in the color space are feasible. In the case of a change of the image content, it is further possible to stop the activity of the method of the invention in one image area only, that is to say, locally.

The present invention presents a method by means of which image sticking can be prevented in any display panel during operation without considerably impairing the readability of the panel. The requirement and the aim of achieving a true-to-original image display as far as possible and a high level of user acceptance are therefore met very effectively.

On the whole, excellent results are achieved by the method of the invention. During the active phase of the method of the invention, renewed image sticking, i.e. the fixation of new images or structures, is prevented, and a stuck image is reduced or corrected. In the case of reversible sticking effects, the difference between the correction or remedy of sticking effects and the prevention of image sticking is not noticeable after a few days of applying the method of the invention. In the case of strong sticking effects, the remedying method may require a period of several weeks, but excellent results are still achieved in suppressing image sticking. The aim of obtaining the best possible subjective readability of all image details concurrently with the active phase of the method of suppressing image sticking is achieved by the invention very effectively and, above all, at low expense.

1. A method for reducing image sticking in liquid crystal display panels, in which the liquid crystal display panel is controlled by a control program running on a logic device, comprising:
subjecting at least a number of selected pixels in the liquid crystal display panel to modified control at least for a specified period of time instead of the control normally necessary to display a specific image; and
performing the modified control under a condition that a maximum contrast between the selected pixels and adjacent pixels is reduced.

2. The method as defined in claim 1, wherein the modified control is carried out under a condition that a contrast range of at least a portion of an image displayed by the liquid crystal display panel is reduced.

3. The method as defined in claim 1, wherein the modified control is carried out under a condition that an average contrast between the selected pixels and adjacent pixels is reduced.

4. The method as defined in claim 1, wherein the modified control is carried out under a condition that a contrast reduction takes place only for pixels whose contrast range relative to adjacent pixels exceeds a specifiable threshold.

5. The method as defined in claim 1, wherein all of the pixels in the liquid crystal display panel are subjected to the modified control.

6. The method as defined in claim 1, wherein control parameters for the modified control are provided by modifying control parameters for normal display of the image such that a brightness of the pixels is scaled by a monotonic function.

7. The method as defined in claim 1, wherein control parameters for the modified control are selected under a condition that a brightness of each individual pixel is increased, whilst a change in brightness of a pixel compared with normal display conditions is greater the darker the pixel is under normal display conditions.

8. The method as defined in claim 1, wherein control parameters for the modified control are selected under a condition that a brightness of each individual pixel is decreased, whilst a change in brightness of a pixel compared with normal display conditions is greater the brighter the pixel is under normal display conditions.

9. The method as defined in claim 1, wherein the modified control is carried out for a period of time of at least several seconds.

10. The method as defined in claim 1, wherein at a commencement of a cycle a first aliquot of pixels is subjected to the modified control for a specified period of time, whereupon further aliquots of pixels differing from each other and from the first aliquot are successively subjected to the modified control for a specified period of time until all of the pixels in the image have been subjected to the modified control at least once, after which the cycle is recommenced.

11. The method as defined in claim 1, wherein the modified control is only effective when the image remains unchanged over a specifiable period of time.

12. The method as defined in claim 1, wherein the modified control is applied to a subregion of the liquid crystal display panel only when the subregion has displayed a static image for a specifiable period of time.

13. The method as defined in claim 1, wherein control parameters for the modified control of a pixel are obtained from control parameters for the pixel under normal display conditions and the control parameters for the normal display conditions are modified so as to approach average values of the control parameters of pixels in a vicinity of the pixel.

14. The method as defined in claim 1, wherein the control parameters for the modified control of a pixel are obtained from control parameters for the pixel under normal display conditions and the control parameters for the normal display conditions are modified so as to approach average values of the control parameters of all of the pixels.

15. The method as defined in claim 1, wherein a fraction of the pixels that are simultaneously subjected to the modified control are adjusted according to a perceptibility of the image to a user.

16. The method as defined in claim 1, wherein when an image content is modified, the pixels in the liquid crystal display panel are subjected to the control used for normal display conditions.

17. The method as defined in claim 16, wherein when there is interaction by a user, the pixels in the liquid crystal display panel are subjected to the control used for normal display conditions.

18. A device for reducing image sticking in a liquid crystal display panel, comprising:
a logic device for controlling the liquid crystal display panel based on a control program running on the logic device, wherein at least a number of selected pixels in the liquid crystal display panel are subjected to modified control at least for a specified period of time instead of the control normally necessary to display a specific image;
wherein the control program is adapted to carry out the modified control under a condition that a maximum contrast between the selected pixels and adjacent pixels is reduced.

19. The device as defined in claim 18, wherein the liquid crystal display panel is controlled by a microcontroller, and wherein the microcontroller comprises a programmable logic device on which the control program is stored.

20. A computer program comprising program code for executing the method as defined in claim 1 when the computer program is running on the logic device.

21. A machine-readable data carrier with stored program code for executing a method as defined in claim 1 when the computer program is running on the logic device.
